(19) United States
(12) Patent Application Publication
(10) Pub. No.: US 2025/0055218 A1
(43) Pub. Date: Feb. 13, 2025

(54) DOUBLE-ROW CONNECTOR SUPPORTING PLASTIC COATING

(71) Applicant: Huizhou Sanchuang Technology Co., Ltd., Huizhou (CN)

(72) Inventor: Helen Huang, Ruian (CN)

(21) Appl. No.: 18/493,622

(22) Filed: Oct. 24, 2023

(30) Foreign Application Priority Data
Aug. 7, 2023 (CN) 202322108028.4

(51) Int. Cl. H01R 13/424; H01R 13/502

(52) U.S. Cl. CPC H01R 13/424; H01R 13/502

(57) ABSTRACT

Provided is a double-row connector supporting plastic coating. The double-row connector includes a double-row connector body, where the double-row connector body consists of a first single-row-pin connector body and a second single-row-pin connector body, the first single-row-pin connector body and the second single-row-pin connector body are provided with no less than one group of pins, and the pin is provided with an anti-deformation structure and wrapped in a plastic coating body. According to the present invention, the double-row connector body is configured into a connector body having the first single-row-pin connector body and the second single-row-pin connector body that are separate from each other, and is assembled into a double-row-pin connector by means of interference fit of the shaft and the hole, and the problems of glue moving and pin pressing are prevented when a plastic coating boundary of the connector is subjected to secondary plastic coating.

### CROSS-REFERENCE TO RELATED APPLICATIONS

This application claims priority of Chinese Patent Application No. 202322108028.4, filed on Aug. 7, 2023, the entire contents of which are incorporated herein by reference.

### TECHNICAL FIELD

The present invention relates to a connector, in particular to a double-row connector supporting plastic coating.

### BACKGROUND

A connector is used for connecting a power supply and an electronic signal, which produces electrical connection by means of a mechanical method. The connector is widely used in a variety of electronic devices, communication devices, instruments, intelligent program control devices, lighting devices, alarm apparatuses, household appliances and power products, includes a display, a computer mother board, a radiator, a stored program control exchange, a digital camera, a mobile pentium 4 (MP4), various removable storage disks, a cordless phone, a walkie-talkie, a mobile phone, a digital appliance, an electronic toy, etc., and provides precise and reliable electrical connection for a variety of products.

Some double-row-pin connectors circulating on the market generally adopt a mode of plugging a pin on a rubber housing. Due to structural reasons of an injection mold, the connector having a pin plugged cannot be plastic-coated at a periphery, which will cause the problems of glue moving and pin pressing. Therefore, it is necessary to design a double-row connector that separates single-row pins for plastic coating and then combines the single-row pins into double-row pins to avoid glue moving.

### SUMMARY

An objective of the present invention is to provide a double-row connector supporting plastic coating, which can prevent glue moving and pin pressing.

In order to achieve the above objective, the present invention provides a double-row connector supporting plastic coating. The double-row connector includes a double-row connector body formed by secondary plastic coating, where the double-row connector body consists of a first single-row-pin connector body and a second single-row-pin connector body, where the first single-row-pin connector body and the second single-row-pin connector body are assembled by means of interference fit of a shaft and a hole, the first single-row-pin connector body and the second single-row-pin connector body are provided with no less than one group of pins, at least one end of the pin is arranged at 90°, the pin is provided with an anti-deformation structure matching the shaft and the hole, the pin is wrapped in a plastic coating body, and two ends of the pin are partially exposed out of the plastic coating body.

Specifically, the plastic coating body of the first single-row-pin connector body is provided with the holes, and the plastic coating body of the second single-row-pin connector body is provided with the shafts in interference fit with the holes.

Specifically, a circumferential surface of the shaft is provided with a fillet extending in a direction of the shaft, and the fillet is in transition fit with an inner wall of the hole.

Specifically, the anti-deformation structure includes a semicircular recess provided in the pin.

Specifically, the pin includes a first contact portion and a second contact portion, where the first contact portion and the second contact portion are integrated, the second contact portion is perpendicular to the first contact portion at 90°, and the first contact portion and the second contact portion are partially exposed out of the plastic coating body.

Specifically, exposed portions of the first contact portion and the second contact portion have thicknesses less than those of portions wrapped in the plastic coating body.

Specifically, tail ends of the first contact portion and the second contact portion are chamfered.

Specifically, a tail end of the shaft is rounded.

Specifically, a diameter of the fillet in the direction of the shaft is gradually reduced.

Compared with the prior art, this embodiment of the present invention has the following beneficial effects: the double-row connector body is configured into a connector body having the first single-row-pin connector body and the second single-row-pin connector body that are separate from each other, and is assembled into a double-row-pin connector by means of interference fit of the shaft and the hole; the problems of glue moving and pin pressing are prevented when a plastic coating boundary of the connector is subjected to secondary plastic coating; and moreover, the anti-deformation structure is arranged, thereby preventing deformation of the pin when the first single-row-pin connector body and the second single-row-pin connector body are assembled, and effectively ensuring quality of a product.

### BRIEF DESCRIPTION OF THE DRAWINGS

FIG. 1 is a schematic structural diagram of the present invention;

FIG. 2 is an exploded view of the present invention;

FIG. 3 is a sectional view of assembly of a shaft and a hole of the present invention; and

FIG. 4 is a sectional view of a first single-row-pin connector body of the present invention.

### DETAILED DESCRIPTION OF THE EMBODIMENTS

In order to make the above objectives, features, and advantages of the present invention more apparent and understandable, the particular implementations of the present invention will be described in detail below in conjunction with the accompanying drawings. Many specific details are elaborated in the following description to facilitate a full understanding of the present invention. However, the present invention can be implemented in many other ways different from those described herein, and those skilled in the art can make similar improvements without violating the connotation of the present invention. Therefore, the present invention is not limited by the specific examples disclosed below.

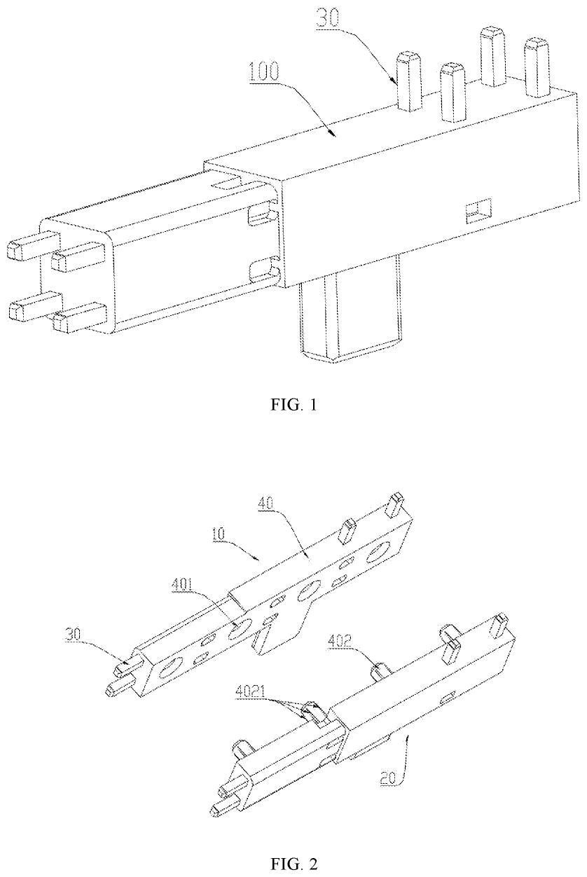

With reference to FIGS. 1, 2 and 3, this embodiment provides a double-row connector supporting plastic coating. The double-row connector supporting plastic coating includes a double-row connector body 100 formed by secondary plastic coating, where the double-row connector body 100 consists of a first single-row-pin connector body 10 and a second single-row-pin connector body 20, where the first single-row-pin connector body 10 and the second single-row-pin connector body 20 are assembled by means of interference fit of a shaft 402 and a hole 401, the first single-row-pin connector body 10 and the second single-row-pin connector body 20 each consist of pins 30 and plastic coating bodies 40, the first single-row-pin connector body 10 and the second single-row-pin connector body 20 are provided with no less than one group of pins 30, the pin 30 is wrapped in the plastic coating body 40, two ends of the pin 30 are partially exposed out of the plastic coating body 40, the plastic coating body 40 of the first single-row-pin connector 10 is provided with the holes 401, no less than 3 holes 401 are provided, the plastic coating body 40 of the second single-row-pin connector 20 is provided with the shafts 402 in interference fit with the holes 401, and the number of the shafts 402 is the same as that of the holes 401. The double-row connector body 100 is configured into a connector body having the first single-row-pin connector body 10 and the second single-row-pin connector body 20 that are separate from each other, and is assembled into a double-row-pin connector by means of interference fit of the shaft 402 and the hole 401, and the problems of glue moving and pin pressing are prevented when a plastic coating boundary of the connector is subjected to secondary plastic coating.

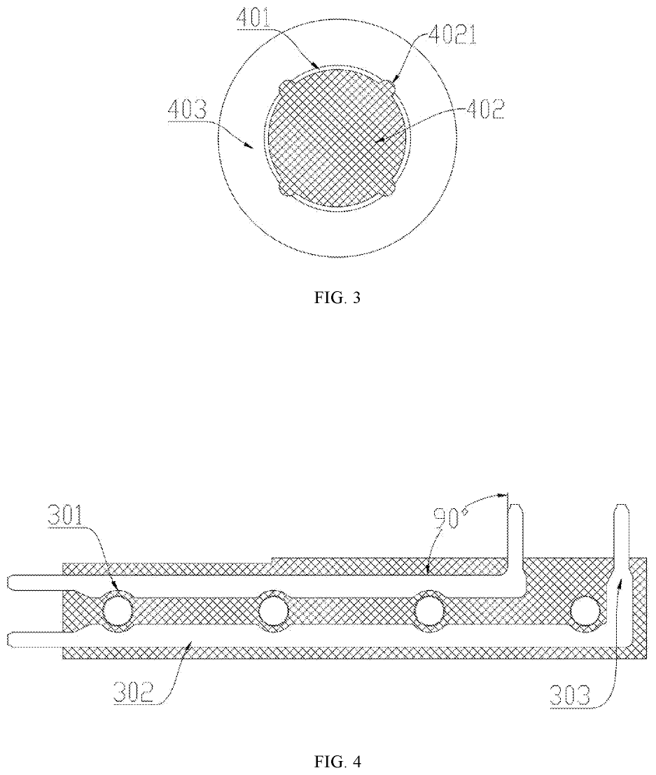

Preferably, in order to prevent movement of the first single-row-pin connector body 10 and the second single-row-pin connector body 20 after the first single-row-pin connector body 10 and the second single-row-pin connector body 20 are connected, with reference to FIG. 3, a circumferential surface of the shaft 402 is provided with a fillet 4021 extending in a direction of the shaft 402, and the fillet 4021 is in transition fit with an inner wall of the hole 401. In order to conveniently and rapidly assemble the first single-row-pin connector body 10 and the second single-row-pin connector body 20, a diameter of the fillet 4021 in the direction of the shaft 402 is gradually reduced, and a tail end of the shaft 402 is rounded. When the shaft 402 is inserted into the hole 401, the shaft can be rapidly inserted because the fillet 4021 at a front end has a small diameter. When the shaft is inserted into the deepest portion, the fillet 4021 can be effectively in transition fit with the inner wall of the hole 401 because the fillet 4021 has a large diameter, thereby preventing loosening of the first single-row-pin connector body 10 and the second single-row-pin connector body 20 after connection, and avoiding the problems of glue moving and pin pressing during secondary plastic coating. In addition, in order to conveniently align the shaft 402 with the hole 401 for insertion, a semicircular groove 403 having a diameter larger than that of the hole 401 is formed on an outer edge of the hole 401.

With reference to FIG. 4, after the shaft 402 is inserted into the hole 401, the diameter of the hole 401 is increased, which easily causes deformation of the pin 30 wrapped in the plastic coating body 40. Therefore, the pin 30 is provided with an anti-deformation structure matching the shaft 402 and the hole 401. The anti-deformation structure includes a semicircular recess 301 provided on the pin 30, where the semicircular recess 301 is located above the hole 401. A tension can be effectively dispersed by means of the circular recess, thereby avoiding deformation of the pin 30. Moreover, in order to produce the pins 30 in batches, the pin 30 on the second single-row-pin connector body 20 is also provided with a semicircular recess 301. The anti-deformation structure is arranged, thereby preventing deformation of the pin 30 when the first single-row-pin connector body 10 and the second single-row-pin connector body 20 are assembled, and effectively ensuring quality of a product.

Preferably, with reference to FIG. 4, the pin 30 includes a first contact portion 302 and a second contact portion 303, where the first contact portion 302 and the second contact portion 303 are integrated, the semicircular recess 301 is arranged on the first contact portion 302, the second contact portion 303 is perpendicular to the first contact portion 302 at 90°, and the first contact portion 302 and the second contact portion 303 are partially exposed out of the plastic coating body 40. A 90° position of the pin 30 is completely plastic-coated to prevent movement of the pin 30 when the connector is inserted. In addition, exposed portions of the first contact portion 302 and the second contact portion 303 have thicknesses less than those of portions wrapped in the plastic coating body 40, and tail ends of the first contact portion 302 and the second contact portion 303 are chamfered. Insertion of the connector is facilitated by means of the arrangement.

To sum up, according to the present invention, the double-row connector body 100 is configured into a connector body having the first single-row-pin connector body 10 and the second single-row-pin connector body 20 that are separate from each other, and is assembled into a double-row-pin connector by means of interference fit of the shaft 402 and the hole 401; the problems of glue moving and pin pressing are prevented when a plastic coating boundary of the connector is subjected to secondary plastic coating; and moreover, the anti-deformation structure is arranged, thereby preventing deformation of the pin 30 when the first single-row-pin connector body 10 and the second single-row-pin connector body 20 are assembled, and effectively ensuring quality of a product.

In the description herein, it should be understood that the terms “upper”, “lower”, “right”, and other orientation or positional relations are based on the orientation or positional relations shown in the accompanying drawings, are only for the convenience of describing and simplifying operations, rather than indicating or implying that the apparatus or element indicated must have a specific orientation, and be constructed and operated in a specific orientation, and therefore cannot be constructed as limitations to the present invention. In addition, the terms “first” and “second” are only used to distinguish the descriptions and have no special meaning.

The technical features of the above examples can be combined arbitrarily. For the sake of brevity, all possible combinations of the technical features in the above examples are not described. However, as long as the combinations of these technical features are not contradicted, it should be regarded as the scope of the description in this specification.

1. A double-row connector supporting plastic coating, comprising: a double-row connector body formed by secondary plastic coating, wherein the double-row connector body consists of a first single-row-pin connector body and a second single-row-pin connector body, wherein the first single-row-pin connector body and the second single-row-pin connector body are assembled by means of interference fit of a shaft and a hole, the first single-row-pin connector body and the second single-row-pin connector body are provided with no less than one group of pins, at least one end of the pin is arranged at 90°, the pin is provided with an anti-deformation structure matching the shaft and the hole, the pin is wrapped in a plastic coating body, and two ends of the pin are partially exposed out of the plastic coating body.

2. The double-row connector supporting plastic coating according to claim 1, wherein the plastic coating body of the first single-row-pin connector body is provided with the holes, and the plastic coating body of the second single-row-pin connector body is provided with the shafts in interference fit with the holes.

3. The double-row connector supporting plastic coating according to claim 2, wherein a circumferential surface of the shaft is provided with a fillet extending in a direction of the shaft, and the fillet is in transition fit with an inner wall of the hole.

4. The double-row connector supporting plastic coating according to claim 1, wherein the anti-deformation structure comprises a semicircular recess provided in the pin.

5. The double-row connector supporting plastic coating according to claim 4, wherein the pin comprises a first contact portion and a second contact portion, wherein the first contact portion and the second contact portion are integrated, the second contact portion is perpendicular to the first contact portion at 90°, and the first contact portion and the second contact portion are partially exposed out of the plastic coating body.

6. The double-row connector supporting plastic coating according to claim 5, wherein exposed portions of the first contact portion and the second contact portion have thicknesses less than those of portions wrapped in the plastic coating body.

7. The double-row connector supporting plastic coating according to claim 6, wherein tail ends of the first contact portion and the second contact portion are chamfered.

8. The double-row connector supporting plastic coating according to claim 2, wherein a tail end of the shaft is rounded.

9. The double-row connector supporting plastic coating according to claim 3, wherein a diameter of the fillet in the direction of the shaft is gradually reduced.
